(19) United States
(12) Patent Application Publication
(10) Pub. No.: US 2012/0230539 A1
(43) Pub. Date: Sep. 13, 2012

(54) PROVIDING LOCATION IDENTIFICATION OF ASSOCIATED INDIVIDUALS BASED ON IDENTIFYING THE INDIVIDUALS IN CONJUNCTION WITH A LIVE VIDEO STREAM

(75) Inventors: Matthew A. Calman, Charlotte, NC (US); Erik Stephen Ross, Charlotte, NC (US); Alfred Hamilton, Charlotte, NC (US)

(73) Assignee: BANK OF AMERICA CORPORATION, Charlotte, NC (US)

(21) Appl. No.: 13/342,057

(22) Filed: Jan. 1, 2012

Related U.S. Application Data
(60) Provisional application No. 61/450,213, filed on Mar. 8, 2011.
(60) Provisional application No. 61/478,415, filed on Apr. 22, 2011.

(51) Int. Cl. G06K 9/00

(52) U.S. Cl. 382/103; 382/100

(57) ABSTRACT

Systems, methods, and computer program products are provided for using real-time video analysis, such as AR or the like to assist the user of a mobile device with commerce activities. Through the use of real-time vision object recognition faces, physical features, objects, logos, artwork, products, locations and other features that can be recognized in the real-time video stream can be matched to data associated with such to assist the user with commerce activity. The commerce activity may include, but is not limited to: identifying individuals associated with the user, identifying locations associated with individuals who are associated with the user, identifying groups of individuals who share a trait, or the like. In specific embodiments, the data that is matched to the images in the real-time video stream is specific to financial institutions, such as customer financial behavior history, customer purchase power/transaction history and the like.

### CROSS-REFERENCE TO RELATED APPLICATIONS

This application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/478,415, filed Apr. 22, 2011, entitled “Providing Location Identification of Associated Individuals Based on Identifying the Individuals in Conjunction With a Live Video Stream,” the entirety of each of which is incorporated herein by reference.

### BACKGROUND

Modern handheld mobile devices, such as smart phones or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have additional features that are becoming increasingly more common and standardized. Such features include, but are not limited to, location-determining devices, such as Global Positioning System (GPS) devices; sensor devices, such as accelerometers; and high-resolution video cameras.

As the hardware capabilities of such mobile devices have increased, so too have the applications (i.e., software) that rely on the hardware advances. One such example of innovative software is a category known as augmented reality (AR), or more generally referred to as mediated reality. One such example of an AR application platform is Layar, available from Layar, Amsterdam, the Netherlands.

The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing”.

As handheld wireless devices have become more popular and prevalent in society, individual users have become more comfortable sharing information about their likes, dislikes, interests, hobbies, relationships, businesses, schedules, plans, experiences, backgrounds, daily encounters and other aspects of their lives, preferences, and personalities with others. Numerous websites and Internet applications allow individuals to share such information with friends, associates, and the public at large. As individuals have become more accustomed to sharing information with others, many individuals have preserved, maintained, and developed relationships and familiarity with increasingly larger numbers of people.

At the same time, many public spaces and facilities have become larger, more crowded, or both. Many stadiums, schools, parks, malls, stores, transportation centers, and other spaces have been expanded or altered to accommodate larger and denser crowds of people. Consequently, it has become increasingly difficult for individuals to locate friends, acquaintances, and associates in a crowded space.

Therefore, a need exists to assist the user of mobile communication devices with locating individuals associated with that user, in particular locating people in crowded spaces, such as auditoriums, stadiums and the like.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program products are described herein that provide for using video analysis, such as AR or the like to assist the user of mobile devices with locating individuals associated with the user, identifying locations where such individuals may be, and identifying individuals in a location who share a trait with each other. Through the use of vision object recognition, objects, logos, artwork, products, locations and other features that can be recognized in the video stream can be matched to data associated with such to assist the user with locating people and places associated with the user, and recognize groups of people who may share a common trait or interest.

In embodiments illustrating one aspect of the invention, methods are disclosed, such methods including: recognizing information associated with an image, wherein the image was captured by a mobile device of a user; determining, based at least partially on the information, that the image depicts an individual associated with the user; and presenting via the mobile device of the user an indicator associated with the individual. In example implementations of this aspect, the methods may be used to identify friends, relatives, business associates, classmates, or other individuals associated with the user of a mobile device who may be interspersed throughout a crowd and depicted in an image captured by the mobile device. When an individual who is associated with the user is identified within an image, an indicator associated with the individual is presented to the user. In some example embodiments, the indicator takes the form of an indicator on the display of the mobile device, such as a border placed around the individual, but any indicator that notifies the user that an individual has been identified may be used. In some such embodiments, the user is presented with additional information about the individual, such as the names of family members, or product preferences, or details of business transactions between the user and the individual.

In embodiments illustrating a second aspect of the invention, methods are disclosed, such methods including: recognizing information associated with an image, wherein the image was captured by a mobile device of a user; determining, based at least partially on the information, that the image depicts a location associated with an individual affiliated with the user; and presenting via the mobile device of the user an indicator associated with the location. In example implementations of this aspect, depictions of locations where an individual has been, currently is, or may be in the future are identified within an image captured by a mobile device. When such a location is identified, an indicator is presented to the user of the mobile device. In such implementations, the user may be able to identify seats in a stadium or other venue where a friend has tickets, or locate restaurants, shops, businesses, or other attractions recommended by an associate. In some such embodiments, the user is presented with additional information about the location, such as friends who have been to the location, comments about the location, and other details about the location.

In embodiments illustrating a third aspect of the invention, methods are disclosed, such methods including: recognizing information associated with an image, wherein the image was captured by a mobile device of a user; determining, based at least partially on the information, that the image depicts a plurality of individuals, wherein the plurality of individuals share a trait; and presenting via the mobile device of the user an indicator associated with the trait. In example implementations of this aspect, information about a group of individuals depicted in an image is analyzed to determine whether some or all of the individuals share a trait, such as a product preference. When such a trait has been identified, the user is presented with an indicator that at least some of the people depicted in the image share a trait. In some such embodiments, a group of individuals is asked to respond to a query. When received, the responses can be analyzed to determine how individuals depicted in an image responded to the query, and whether any of the individuals depicted in the image responded in the same way.

In embodiments illustrating another aspect of the invention, apparatuses are disclosed. Some example apparatuses include a computing device including a memory and at least one processor, and a location identification application stored in memory, executable by the processor, and configured to recognize information associated with an image, wherein the image was captured by a mobile device of a user, determine, based at least partially on the information, that the image depicts an individual associated with the user, and present via the mobile device of the user an indicator associated with the individual. In some example implementations, the mobile device is a mobile phone. In some example implementations, the image is part of a real-time video stream, and in some example implementations, the image is a still image captured by a digital camera. In some such example implementations, and in other example implementations, the information includes Global Positioning System (GPS) coordinates, a compass heading, facial recognition data, and/or a portion of the image. In some example implementations, recognizing information associated with an image includes comparing the information with data stored in a memory system. In some such example implementations, and in other example implementations, determining, based at least partially on the information, that the image depicts an individual associated with the user includes comparing the information with data stored in a memory system. In some example implementations, presenting an indicator associated with the individual includes displaying the indicator on a display of the mobile device. In some such example implementations, and in other example implementations, presenting an indicator associated with the individual includes superimposing the indicator over real-time video that is captured by the mobile device. Such an indicator may include a border that surrounds a depiction of the individual, and the indicator may be selectable by the user. In some example implementations where the indicator is selectable by the user, the location identification application may be further configured to, based at least partially on a selection of the indicator by the user, present information about the individual on a display of the mobile device. In some such example implementations, and in other example implementations, the indicator is a hyperlink that directs the user to a website including information about the individual. In some example implementations, the location identification application is further configured to present information about the individual via the mobile device of the user.

In example embodiments illustrating another aspect of the invention, apparatuses are disclosed. In example implementations of such example embodiments, an apparatus includes a computing device including a memory and at least one processor and a location identification application stored in memory, executable by the processor, and configured to recognize information associated with an image, wherein the image was captured by a mobile device of a user, determine, based at least partially on the information, that the image depicts a location associated with an individual affiliated with the user, and present via the mobile device of the user an indication associated with the location.

In example embodiments illustrating another aspect of the invention, apparatuses are disclosed. In example implementations, an apparatus includes a computing device including a memory and at least one processor and a location identification application stored in memory, executable by the processor, and configured to recognize information associated with an image, wherein the image was captured by a mobile device of a user determine, based at least partially on the information, that the image depicts a plurality of individuals, wherein the plurality of individuals share a trait, and present via the mobile device of the user an indication associated with the trait. In some such example implementations, the trait is a product preference. In some such example implementations, and in other example implementations, the trait is an affiliation with an educational institution. In some example implementations, the trait is an affiliation with a business. In some such example implementations, and in other example implementations the location identification application is further configured to request, from the plurality of individuals, a response to a query; receive a plurality of responses at a mobile device and determine whether the plurality of responses indicate that one or more individuals share a trait.

In example embodiments illustrating another aspect of the invention, computer program products are disclosed. In example implementations, a computer program product includes a non-transitory computer-readable medium including a first set of codes for causing a computer processor to be configured for recognizing information associated with an image, wherein the image was captured by a mobile device of a user, a second set of codes for causing a computer processor to be configured for determining, based at least partially on the information, that the image depicts an individual associated with the user, and a third set of codes for causing a computer processor to be configured for presenting via the mobile device of the user an indication associated with the individual. In some example implementations, the mobile device is a mobile phone. In some such example implementations, and in other example implementations, the image is part of a real-time video stream. In some example implementations, the image is a still image captured by a digital camera. In some example implementations, the information includes Global Positioning System (GPS) coordinates. In some such example implementations and in other example implementations, the information includes a compass heading. In some example implementations, the information includes facial recognition data. In some such example implementations, and in other example implementations, the information includes a portion of the image. In some example implementations, recognizing information associated with an image includes comparing the information with data stored in a memory system. In some example implementations, determining, based at least partially on the information, that the image depicts an individual associated with the user includes comparing the information with data stored in a memory system.

In some such example implementations, and in other example implementations, presenting an indicator associated with the individual includes displaying the indicator on a display of the mobile device. In some such example implementations and in other example implementations, presenting an indicator associated with the individual includes superimposing the indicator over real-time video that is captured by the mobile device. In some example implementations the indicator includes a border that surrounds a depiction of the individual. In some such example implementations and in other example implementations, the indicator is selectable by the user. In some such example implementations and in other example implementations, a computer program product further includes a set of codes configured to cause a computer processor to, at least partially in response to a selection of the indicator by the user, present information about the individual on a display of the mobile device. In some such implementations and in other example implementations, the indicator is a hyperlink that directs the user to a website including information about the individual. In some example implementations, the computer program product further includes a set of codes configured to cause a computer processor to present information about the individual via the mobile device of the user.

In example embodiments illustrating another aspect of the invention, computer program products are disclosed. In example implementations, a computer program product includes a non-transitory computer-readable medium including a first set of codes for causing a computer processor to be configured for recognizing information associated with an image, wherein the image was captured by a mobile device of a user, a second set of codes for causing a computer processor to be configured for determining, based at least partially on the information, that the image depicts a location associated with an individual affiliated with the user, and a third set of codes for causing a computer processor to be configured for presenting via the mobile device of the user an indication associated with the location.

In example embodiments illustrating another aspect of the invention, computer program products are disclosed. In example implementations, a computer program product includes a non-transitory computer-readable medium including a first set of codes for causing a computer processor to be configured for recognizing information associated with an image, wherein the image was captured by a mobile device of a user, a second set of codes for causing a computer processor to be configured for determining, based at least partially on the information, that the image depicts a plurality of individuals, wherein the plurality of individuals share a trait, and a third set of codes for causing a computer processor to be configured for presenting via the mobile device of the user an indication associated with the trait. In some example implementations, the trait is a product preference. In some example implementations, the trait is an affiliation with an educational institution. In some example implementations, the trait is an affiliation with a business. In some such example implementations and in other example implementations, the computer program product includes a fourth set of codes for causing a computer processor to be configured for requesting, from the plurality of individuals, a response to a query, a fifth set of codes for causing a computer processor to be configured for receiving a plurality of responses at a mobile device; and a sixth set of codes for causing a computer processor to be configured for determining whether the plurality of responses indicate that one or more individuals share a trait.

To the accomplishment of the foregoing and related ends, the one or more embodiments include the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile device, in accordance with an embodiment of the invention;

FIG. 2 is a block diagram illustrating an AR environment, in accordance with an embodiment of the invention;

FIG. 3 is a block diagram illustrating a mobile device, in accordance with an embodiment of the invention;

FIG. 4 is a flow diagram illustrating a method for identifying an individual associated with the user of a mobile device in conjunction with an image captured by the mobile device, in accordance with an embodiment of the invention;

FIG. 5 is a flow diagram illustrating a method for identifying a location associated with a user of a mobile device in conjunction with an image captured by the mobile device, in accordance with an embodiment of the invention; and

FIG. 6 is a flow diagram illustrating a method for determining whether individuals depicted in an image captured by a mobile device share a trait, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for using real-time video analysis, such as AR or the like to assist the user of mobile devices with identifying individuals associated with the user, identifying locations associated with individuals who are associated with the user, and identifying the location of a plurality of individuals who share a trait. Through the use real-time vision object recognition, objects, logos, artwork, products, locations and other features that can be recognized in the real-time video stream can be matched to data associated with such to assist the user with activities and methods described herein. In specific embodiments, the data that is matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

In yet other embodiments, real-time video analysis, such as AR or the like may be used to assist the user of a mobile device for identifying individuals dynamically, such that two individuals whom are looking for similar features may find each other. The user may input data on the mobile device, such as interests, location, etc. of the user. That data of may be dynamically matched to data of a second user, such that the users may discover each other based on the data provided. For example, if two users are at a conference where they do not know anyone, but would like to network with other individuals at the conference. The two users may provide data to the system such that the two users may seek each other during the conference. The system could match the two users at the conference and provide each of them the name, details, etc. in regard to the other user.

While embodiments discussed herein are generally described with respect to “real-time video streams” or “real-time video” it will be appreciated that the video stream may be captured and stored for later viewing and analysis. Indeed, in some embodiments video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

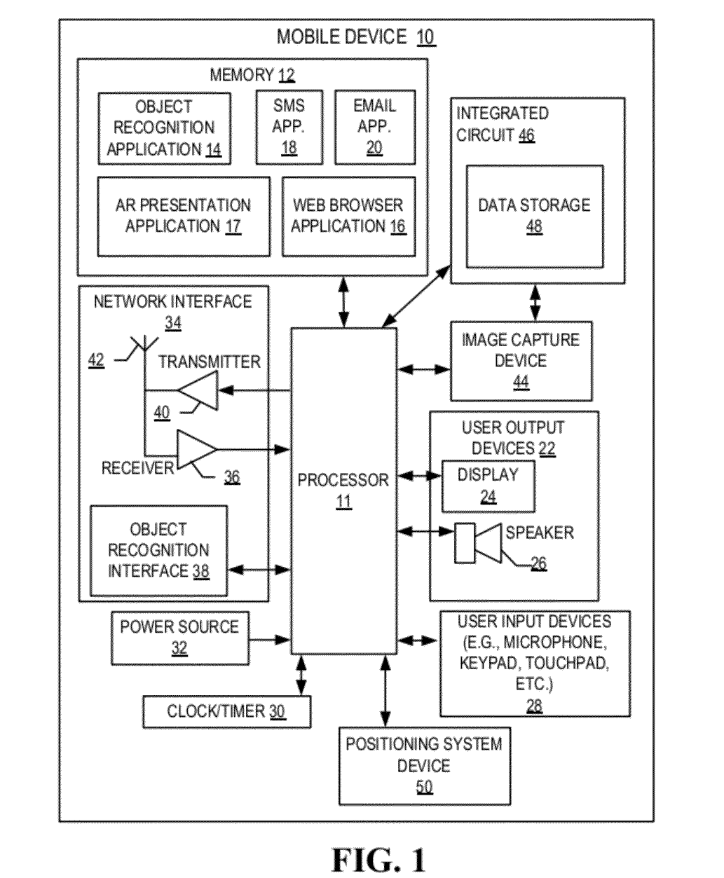

FIG. 1 illustrates an embodiment of a mobile device 10 that may be configured to execute object recognition and Augmented Reality (AR) functionality, in accordance with specific embodiments of the present invention. A “mobile device” 10 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 10 may generally include a processor 11 communicably coupled to such devices as a memory 12, user output devices 22, user input devices 28, a network interface 34, a power source 32, a clock or other timer 30, an image capture device 44, a positioning system device 50 (e.g., a Global Positioning System (GPS) device), one or more integrated circuits 46, etc.

In some embodiments, the mobile device and/or the server access one or more databases or data stores (not shown in FIG. 1) to search for and/or retrieve information related to the object and/or marker. In some embodiments, the mobile device and/or the server access one or more data stores local to the mobile device and/or server and in other embodiments, the mobile device and/or server access data stores remote to the mobile device and/or server. In some embodiments, the mobile device and/or server access both a memory and/or data store local to the mobile device and/or server as well as a data store remote from the mobile device and/or server.

The processor 11, and other processors described herein, may generally include circuitry for implementing communication and/or logic functions of the mobile device 10. For example, the processor 11 may include a digital signal processor device, a microprocessor device, and various analog to digital converters, digital to analog converters, and/or other support circuits. Control and signal processing functions of the mobile device 10 may be allocated between these devices according to their respective capabilities. The processor 11 thus may also include the functionality to encode and interleave messages and data prior to modulation and transmission. The processor 11 may additionally include an internal data modem. Further, the processor 11 may include functionality to operate one or more software programs or applications, which may be stored in the memory 12. For example, the processor 11 may be capable of operating a connectivity program, such as a web browser application 16. The web browser application 16 may then allow the mobile device 10 to transmit and receive web content, such as, for example, location-based content and/or other web page content, according to a Wireless Application Protocol (WAP), Hypertext Transfer Protocol (HTTP), and/or the like.

The processor 11 may also be capable of operating applications, such as an object recognition application 14. The object recognition application 14 may be downloaded from a server and stored in the memory 12 of the mobile device 10. Alternatively, the object recognition application 14 may be pre-installed and stored in a memory in the integrated circuit 46. In such an embodiment, the user may not need to download the object recognition application 14 from a server. In some embodiments, the processor 11 may also be capable of operating one or more applications, such as one or more applications functioning as an artificial intelligence (“AI”) engine. The processor 11 may recognize objects that it has identified in prior uses by way of the AI engine. In this way, the processor 11 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

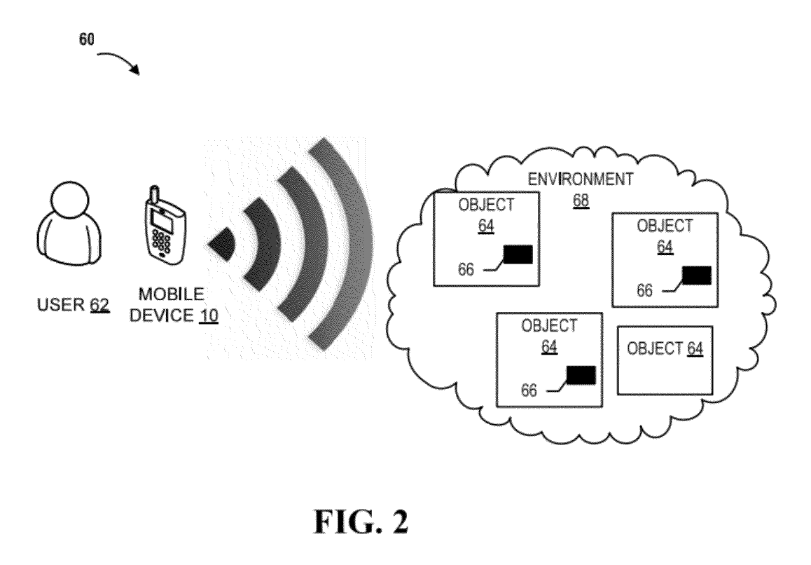

The integrated circuit 46 may include the necessary circuitry to provide the object recognition functionality to the mobile device 10. Generally, the integrated circuit 46 will include data storage 48 which may include data associated with the objects within a video stream that the object recognition application 14 identifies as having a certain marker(s) (discussed in relation to FIG. 2). The integrated circuit 46 and/or data storage 48 may be an integrated circuit, a microprocessor, a system-on-a-integrated circuit, a microcontroller, or the like. As discussed above, in one embodiment, the integrated circuit 46 may provide the functionality to the mobile device 10.

Of note, while FIG. 1 illustrates the integrated circuit 46 as a separate and distinct element within the mobile device 10, it will be apparent to those skilled in the art that the object recognition functionality of integrated circuit 46 may be incorporated within other elements in the mobile device 10. For instance, the functionality of the integrated circuit 46 may be incorporated within the mobile device memory 12 and/or processor 11. In a particular embodiment, the functionality of the integrated circuit 46 is incorporated in an element within the mobile device 10 that provides object recognition capabilities to the mobile device 10. Still further, the integrated circuit 46 functionality may be included in a removable storage device such as an SD card or the like.

The processor 11 may be configured to use the network interface 34 to communicate with one or more other devices on a network. In this regard, the network interface 34 may include an antenna 42 operatively coupled to a transmitter 40 and a receiver 36 (together a “transceiver”). The processor 11 may be configured to provide signals to and receive signals from the transmitter 40 and receiver 36, respectively. The signals may include signaling information in accordance with the air interface standard of the applicable cellular system of the wireless telephone network that may be part of the network. In this regard, the mobile device 10 may be configured to operate with one or more air interface standards, communication protocols, modulation types, and access types. By way of illustration, the mobile device 10 may be configured to operate in accordance with any of a number of first, second, third, and/or fourth-generation communication protocols and/or the like. For example, the mobile device 10 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 10 may also be configured to operate in accordance with non-cellular communication mechanisms, such as via a wireless local area network (WLAN) or other communication/data networks.

The network interface 34 may also include an object recognition interface 38 in order to allow a user to execute some or all of the above-described processes with respect to the object recognition application 14 and/or the integrated circuit 46. The object recognition interface 38 may have access to the hardware, e.g., the transceiver, and software previously described with respect to the network interface 34. Furthermore, the object recognition interface 38 may have the ability to connect to and communicate with an external data storage on a separate system within the network as a means of recognizing the object(s) in the video stream.

As described above, the mobile device 100 may have a user interface that includes user output devices 22 and/or user input devices 28. The user output devices 22 may include a display 24 (e.g., a liquid crystal display (LCD) or the like) and a speaker 26 or other audio device, which are operatively coupled to the processor 11. The user input devices 28, which may allow the mobile device 10 to receive data from a user, may include any of a number of devices allowing the mobile device 10 to receive data from a user, such as a keypad, keyboard, touch-screen, touchpad, microphone, mouse, joystick, other pointer device, button, soft key, and/or other input device(s).

The mobile device 10 may further include a power source 32. Generally, the power source 32 is a device that supplies electrical energy to an electrical load. In one embodiment, power source 32 may convert a form of energy such as solar energy, chemical energy, mechanical energy, etc. to electrical energy. Generally, the power source 32 in a mobile device 10 may be a battery, such as a lithium battery, a nickel-metal hydride battery, or the like, that is used for powering various circuits, e.g., the transceiver circuit, and other devices that are used to operate the mobile device 10. Alternatively, the power source 32 may be a power adapter that can connect a power supply from a power outlet to the mobile device 10. In such embodiments, a power adapter may be classified as a power source “in” the mobile device.

The mobile device 10 may also include a memory 12 operatively coupled to the processor 11. As used herein, memory may include any computer readable medium configured to store data, code, or other information. The memory 12 may include volatile memory, such as volatile Random Access Memory (RAM) including a cache area for the temporary storage of data. The memory 12 may also include non-volatile memory, which can be embedded and/or may be removable. The non-volatile memory may additionally or alternatively include an electrically erasable programmable read-only memory (EEPROM), flash memory or the like.

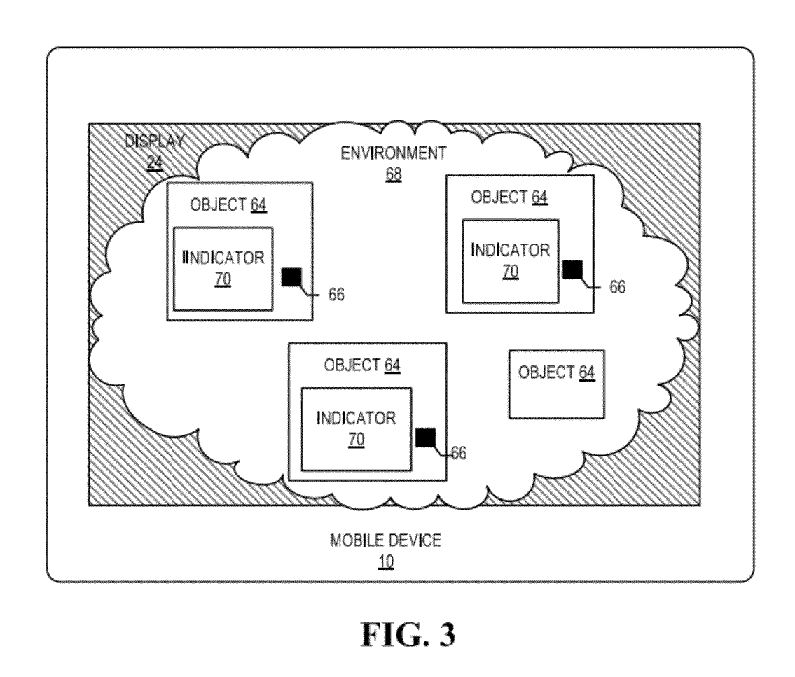

The memory 12 may store any of a number of applications or programs which comprise computer-executable instructions/code executed by the processor 11 to implement the functions of the mobile device 10 described herein. For example, the memory 12 may include such applications as an object recognition application 14, an augmented reality (AR) presentation application 17 (described infra. in relation to FIG. 3), a web browser application 16, a Short Message Service (SMS) application 18, an electronic mail (i.e., email) application 20, etc.

Referring to FIG. 2, a block diagram illustrating an object recognition experience 60 in which a user 62 utilizes a mobile device 10 to capture a video stream that includes an environment 68 is shown. As denoted earlier, the mobile device 10 may be any mobile communication device. The mobile device 10 has the capability of capturing a video stream of the surrounding environment 68. The video capture may be by any means known in the art. In one particular embodiment, the mobile device 10 is a mobile telephone equipped with an image capture device 44 capable of video capture.

The environment 68 contains a number of objects 64. Some of such objects 64 may include a marker 66 identifiable to an object recognition application that is either executed on the mobile device 10 or within the wireless network. A marker 66 may be any type of marker that is a distinguishing feature that can be interpreted by the object recognition application to identify specific objects 64. For instance, a marker 66 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 66 may be audio and the mobile device 10 may be capable of utilizing audio recognition to identify words or unique sounds broadcast. The marker 66 may be any size, shape, etc. Indeed, in some embodiments, the marker 66 may be very small relative to the object 64 such as the alpha-numeric characters that identify the name or model of an object 64, whereas, in other embodiments, the marker 66 is the entire object 64 such as the unique shape, size, structure, etc.

In some embodiments, the marker 66 is not actually a physical marker located on or being broadcast by the object 64. For instance, the marker 66 may be some type of identifiable feature that is an indication that the object 64 is nearby. In some embodiments, the marker 66 for an object 64 may actually be the marker 66 for a different object 64. For example, the mobile device 10 may recognize a particular building as being “Building A.” Data stored in the data storage 48 may indicate that “Building B” is located directly to the east and next to “Building A.” Thus, markers 66 for an object 64 that are not located on or being broadcast by the object 64 are generally based on fixed facts about the object 64 (e.g., “Building B” is next to “Building A”). However, it is not a requirement that such a marker 66 be such a fixed fact. The marker 66 may be anything that enables the mobile device 10 and associated applications to interpret to a desired confidence level what the object is. For another example, the mobile device 10, object recognition application 14 and/or AR presentation application 17 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 66 may also be or include social network data, such as data retrieved or communicated from the Internet, such as tweets, blog posts, online networking posts, various types of messages and/or the like. In other embodiments, the marker 66 is provided in addition to social network data as mentioned above. For example, the mobile device 10 may capture a video stream and/or one or more still shots of a large gathering of people. In this example, as above, one or more people dressed as characters in costumes may be present at a specified location. The mobile device 10, object recognition application 14, and/or the AR presentation application 17 may identify several social network indicators, such as posts, blogs, tweets, messages, and/or the like indicating the presence of one or more of the characters at the specified location. In this way, the mobile device 10 and associated applications may communicate information regarding the social media communications to the user and/or use the information regarding the social media communications in conjunction with other methods of object recognition. For example, the mobile device 10 object recognition application 14, and/or the AR presentation application 17 performing recognition of the characters at the specified location may confirm that the characters being identified are in fact the correct characters based on the retrieved social media communications. This example may also be applied objects outside of people.

In some embodiments, the mobile device and/or server access one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 64 with markers 66 only include a single marker 66, it will be appreciated that the object 64 may have any number of markers 66 with each equally capable of identifying the object 66. Similarly, multiple markers 66 may be identified by the mobile device 10 and associated applications such that the combination of the markers 66 may be utilized to identify the object 64. For example, the mobile device 10 may utilize facial recognition markers 66 to identify a person and/or utilize a separate marker 66, such as the clothes the person is wearing to confirm the identification to the desired confidence level that the person is in fact the person the mobile device identified. For example, the facial recognition may identify a person as a famous athlete, and thereafter utilize the uniform the person is wearing to confirm that it is in fact the famous athlete.

In some embodiments, a marker 66 may be the location of the object 64. In such embodiments, the mobile device 10 may utilize Global Positioning System (GPS) hardware and/or software or some other location determining mechanism to determine the location of the user 62 and/or object 64. As noted above, a location-based marker 66 could be utilized in conjunction with other non-location-based markers 66 identifiable and recognized by the mobile device 10 to identify the object 64. However, in some embodiments, a location-based marker may be the only marker 66. For instance, in such embodiments, the mobile device 10 may utilize GPS software to determine the location of the user 62 and a compass device or software to determine what direction the mobile device 10 is facing in order to identify the object 64. In still further embodiments, the mobile device 10 does not utilize any GPS data in the identification. In such embodiments, markers 66 utilized to identify the object 64 are not location-based.

FIG. 3 illustrates a mobile device 10, specifically the display 24 of the mobile 10, wherein the device 10 has executed an object recognition application 14 and an AR presentation application 17 to present within the display 24 indications of recognized objects within the live video stream (i.e., surrounding environment 68). The mobile device 10 is configured to rely on markers 66 to identify objects 64 that are associated with product offers, products with extended warranties, new products and the like, and indicate to the user 62 the identified objects 64 by displaying an indicator 70 on the mobile device display 130 in conjunction with display of the live video stream. As illustrated, if an object 64 does not have any markers 66 (or at least enough markers 66 to yield object identification), the object 64 will be displayed without an associated indicator 70.

The object recognition application 14 may use any type of means in order to identify desired objects 64. For instance, the object recognition application 14 may utilize one or more pattern recognition algorithms to analyze objects in the environment 68 and compare with markers 66 in data storage 48 which may be contained within the mobile device 10 (such as within integrated circuit 46) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 64 within the real-time video stream, the AR presentation application 17 is configured to superimpose an indicator 70 on the mobile device display 24. The indicator 70 is generally a graphical representation that highlights or outlines the object 64 and may be activatable (i.e., include an embedded link), such that the user 62 may “select” the indicator 70 and retrieve information related to the identified object. The information may include any desired information associated with the selected object and may range from basic information to greatly detailed information. In some embodiments, the indicator 70 may provide the user 62 with an internet hyperlink to further information on the object 64. The information may include, for example, all types of media, such as text, images, clipart, video clips, movies, or any other type of information desired. In yet other embodiments, the indicator 70 information related to the identified object may be visualized by the user 62 without “selecting” the indicator 70.

In embodiments in which the indicator 70 provides an interactive tab to the user 62, the user 62 may select the indicator 70 by any conventional means, e.g., keystroke, touch, voice command or the like, for interaction with the mobile device 10. For instance, in some embodiments, the user 62 may utilize an input device 28 such as a keyboard to highlight and select the indicator 70 in order to retrieve the information. In a particular embodiment, the mobile device display 24 includes a touch screen that the user may employ to select the indicator 70 utilizing the user's finger, a stylus, or the like.

In some embodiments, the indicator 70 is not be interactive and simply provides information to the user 62 by superimposing the indicator 70 onto the display 24. For example, in some instances it may be beneficial for the AR presentation application 17 to merely identify an object 64, e.g., just identify the object's name/title, give brief information about the object, etc., rather than provide extensive detail that requires interaction with the indicator 70. The AR presentation application 17 is capable of being tailored to a user's desired preferences.

Furthermore, the indicator 70 may be displayed at any size on the mobile device display 24. The indicator 70 may be small enough that it is positioned on or next to the object 64 being identified such that the object 64 remains discernable behind the indicator 70. Additionally, the indicator 70 may be semi-transparent or an outline of the object 64, such that the object 64 remains discernable behind or enclosed by the indicator 70. In other embodiments, the indicator 70 may be large enough to completely cover the object 64 portrayed on the display 24. Indeed, in some embodiments, the indicator 70 may cover a majority or the entirety of the mobile device display 24.

The user 62 may opt to execute the object recognition application 14 and AR presentation application 17 at any desired moment and begin video capture and analysis. However, in some embodiments, the object recognition application 14 and AR presentation application 17 includes an “always on” feature in which the mobile device 10 is continuously capturing video and analyzing the objects 64 within the video stream. In such embodiments, the object recognition application 14 may be configured to alert the user 62 that a particular object 64 has been identified. The user 62 may set any number of user preferences to tailor the object recognition and AR presentation experience to their needs. For instance, the user 62 may opt to only be alerted if a certain particular object 64 is identified. Additionally, it will be appreciated that the “always on” feature in which video is continuously captured may consume the mobile device power source 32 more quickly. Thus, in some embodiments, the “always on” feature may disengage if a determined event occurs such as low power source 32, low levels of light for an extended period of time (e.g., such as if the mobile device 10 is in a user's pocket obstructing a clear view of the environment 68 from the mobile device 10), if the mobile device 10 remains stationary (thus receiving the same video stream) for an extended period of time, the user sets a certain time of day to disengage, etc. Conversely, if the “always on” feature is disengaged due to the occurrence of such an event, the user 62 may opt for the “always on” feature to re-engage after the duration of the disengaging event (e.g., power source 32 is re-charged, light levels are increased, etc.).

In some embodiments, the user 62 may identify objects 64 that the object recognition application 14 does not identify and add it to the data storage 48 with desired information in order to be identified and/or displayed in the future. For instance, the user 62 may select an unidentified object 64 and enter a name/title and/or any other desired information for the unidentified object 64. In such embodiments, the object recognition application 14 may detect/record certain markers 66 about the object so that the pattern recognition algorithm(s) (or other identification means) may detect the object 64 in the future. Furthermore, in cases where the object information is within the data storage 48, but the object recognition application 14 fails to identify the object 64 (e.g., one or more identifying characteristics or markers 66 of the object has changed since it was added to the data storage 48 or the marker 66 simply was not identified), the user 62 may select the object 64 and associate it with an object 64 already stored in the data storage 48. In such cases, the object recognition application 14 may be capable of updating the markers 66 for the object 64 in order to identify the object in future video streams.

In addition, in some embodiments, the user 62 may opt to edit the information or add to the information provided by the indicator 70. For instance, the user 62 may opt to include user-specific information about a certain object 64 such that the information may be displayed upon a future identification of the object 64. Conversely, in some embodiments, the user may opt to delete or hide an object 64 from being identified and an indicator 70 associated therewith being displayed on the mobile device display 24.

Furthermore, in some instances, an object 64 may include one or more markers 66 identified by the object recognition application 14 that leads the object recognition application 14 to associate an object with more than one objects in the data storage 48. In such instances, the user 62 may be presented with multiple candidate identifications and may opt to choose the appropriate identification or input a different identification. The multiple candidates may be presented to the user 62 by any means. For instance, in one embodiment, the candidates are presented to the user 62 as a list wherein the “strongest” candidate is listed first based on reliability of the identification. Upon input by the user 62 identifying the object 64, the object recognition application 14 may “learn” from the input and store additional markers 66 in order to avoid multiple identification candidates for the same object 64 in future identifications.

Additionally, the object recognition application 14 may utilize other metrics for identification than identification algorithms. For instance, the object recognition application 14 may utilize the user's location, time of day, season, weather, speed of location changes (e.g., walking versus traveling), “busyness” (e.g., how many objects are in motion versus stationary in the video stream), as well any number of other conceivable factors in determining the identification of objects 64. Moreover, the user 62 may input preferences or other metrics for which the object recognition application 14 may utilize to narrow results of identified objects 64.

In some embodiments, the AR presentation application 17 may have the ability to gather and report user interactions with displayed indicators 70. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

In some embodiments, AR application 17 and/or object recognition application 14 may include a location identification application configured to perform any of the processes and/or methods described herein.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

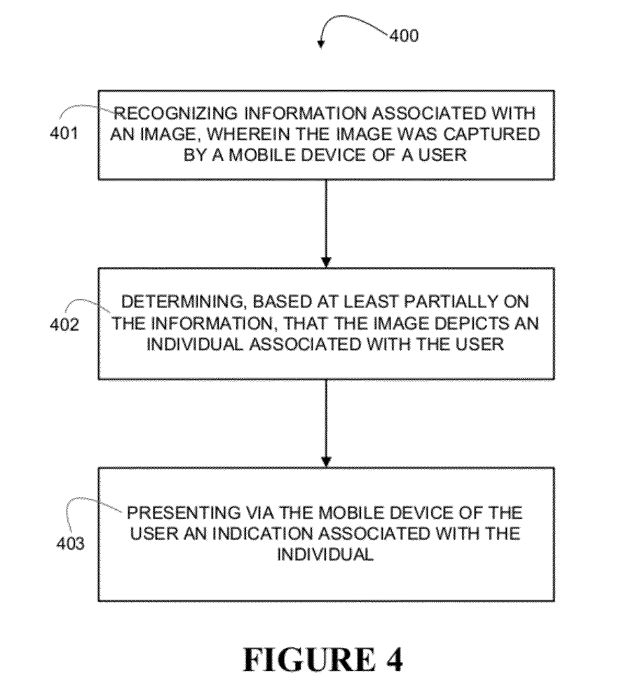

FIG. 4 depicts a method 400 in accordance with one aspect of the invention. As shown in element 401, the method includes recognizing information associated with an image, wherein the image was captured by a mobile device of a user. In some implementations of element 401, the mobile device is a mobile telephone. However, any mobile device capable of capturing an image may be used or be configured to be used in implementations of element 401. For example, a mobile device may be any device described in relation to FIGS. 1-3.

In element 401, the image captured by the mobile device may be any type of image, including without limitation the images described in relation to FIGS. 1-3. For example, the image may be part of a video stream. In other example implementations of method 400, the image may be a still image captured by a digital camera. It will be appreciated that while many implementations will use images based on visible wavelengths of light, other implementations may use images including representations of non-visible wavelengths, such as those produced by cameras configured to perform infrared, ultraviolet, low-light, night-vision, or other image-capture functions.

As referred to in element 401, the information associated with the image may include any data included in, relating to, stored with, and/or used to render the image, including, without limitation, metadata. In some example implementations, the information includes Global Positioning System (GPS) coordinates and/or compass headings, either individually or in combination. In other example implementations, the information includes a portion of the image. The information may include any or all of the markers referred to in the discussion of FIGS. 1-3 above, or any other data described herein. Facial recognition data may also be included in the information associated with the image in element 401, in conjunction with or independent of any other type of information gathered when the image is captured.

In method 400, element 401 includes recognizing information associated with an image, wherein the image was captured by a mobile device of a user. In some implementations of element 401, recognizing information associated with an image includes comparing the information with data stored in a memory system. A memory system may include one or more of any of the computer-readable memory storage devices described in relation to FIGS. 1-3, and/or may include databases, websites, servers, or any other data-storage medium integrated into the mobile device or located remote to the mobile device and accessed by the mobile device via a network connection, air interface, or other connection. Comparing the information to data stored in a memory system may include performing database searches, executing data analysis applications or algorithms, or any other procedure wherein a portion of the information associated with the image is compared to another set or subset of data. For example, if GPS and compass directional data are associated with an image, that information may be compared to data stored in a web-accessible database that identifies major landmarks, buildings, portions of structures, or other features that are viewable from the position and orientation where the image was captured.

As depicted in element 402, method 400 includes determining, based at least partially on the information, that the image depicts an individual associated with the user. In example implementations of element 402, determining, based at least partially on the information, that the image depicts an individual associated with the user includes comparing the information associated with the captured image with data describing individuals associated with the user. Individuals associated with the user may be the user's friends, family members, neighbors, coworkers, business associates, classmates, social acquaintances, community members, second degree friendships (i.e. friends of friends) and/or any other people affiliated with the user. For example, all of the user's online social networking contacts could be considered to be associated with the user. Current, potential, and/or former customers and clients could be considered to be associated with the user. Individuals whose contact information is accessible through the user's electronic mail or other applications could also be considered to be associated with the user. In some example implementations, element 402 includes comparing the information with data stored in a memory system. Such memory systems may include any of the memory systems described herein with respect to FIGS. 1-3 and/or element 401 above.

In one example implementation of element 402, facial recognition information is associated with the image captured by the mobile device. To determine if the image depicts an individual associated with the user, the facial recognition information is compared to photographs and other images stored on the user's mobile device, and against photographs accessible by the user, such as images posted to social networking websites, images stored on personal and/or public databases, and/or other image repositories, such as image-hosting sites, news services, and other websites. If the comparison between the facial recognition information associated with the captured image and another image indicates a match, it is likely that the captured image depicts an individual associated with the user.

Method 400 also includes element 403. As depicted in FIG. 4, element 403 includes presenting via the mobile device of the user an indication associated with the individual. Some example implementations of element 403 include the approaches described above with respect to FIGS. 1-3, including, but not limited to the implementation of a virtual image 300 as discussed with respect to FIG. 3. In some example implementations of element 403, presenting an indicator associated with the individual includes displaying the indicator on a display of the mobile device. This indicator may take the form of an icon or other image displayed on a screen integrated into the mobile device. In other implementations of element 403, presenting an indicator associated with the individual includes superimposing the indicator over real-time video that is captured by the mobile device. For example, an icon indicating the relationship between the user and the individual may be placed near the depiction of the individual, or a border that surrounds a depiction of the individual may be rendered on the mobile device display.

Further example implementations of element 403 present an indicator that is selectable by the user. In implementations where the display of the mobile device can detect a touch from the user, the user may be able to touch the region of the display where the indicator is presented to select the indicator. In some such implementations of element 403, responsive to a selection of the indicator by the user, information about the individual is presented on a display of the mobile device. For example, selecting the indicator may allow the user to access a hyperlink that directs the user to a website including information about the individual, such as the individual's page on a social-networking website, a biographic page on a company's website, blogs, or a private webpage created by the user to store information about individuals associated with the user. In other example implementations, the indicator itself is hyperlink that directs the user to a website including information about the individual.

In other example implementations of element 403, or the overall method 400, the method includes presenting information about the individual via the mobile device of the user. In examples where information about the individual is stored in memory storage integrated with the mobile device, as discussed with respect to FIGS. 1-3, that information may be displayed or otherwise presented to the user. Examples of information that may be presented to the user include, but are not limited to, the name of the individual, names of the individual's family members, audio files with proper pronunciations of the individual's name and/or the names of the individual's family members, the individual's employer and/or line of business, the nature of the relationship between the user and the individual, product preferences of the individual, community organizations to which the individual belongs, details of business transactions between the user and the individual, and any other information that describes a trait, aspect, or experience of the individual that is known or accessible to the user.

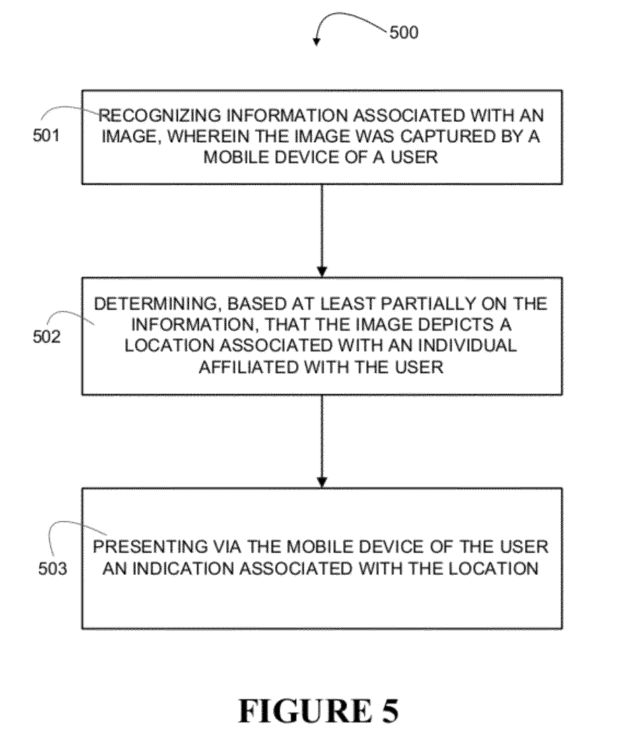

FIG. 5 depicts a method 500 in accordance with another aspect of the invention. As depicted at element 501, the method 500 includes recognizing information associated with an image, wherein the image was captured by a mobile device of a user. In implementations of element 501, the mobile device may be any mobile device described herein, such as the devices mentioned with respect to FIGS. 1-4, including but not limited to a mobile phone. It will be appreciated that the information recognized in element 501 could be any data or metadata associated with an image, such as the example types of data discussed with respect to element 401 in FIG. 4. In many implementations of element 501, the information associated with the image is data pertaining to the position, location, and/or orientation of the mobile device during the capture of the image. For example, the information may include GPS coordinates, compass directions, a directional vector, roll, pitch, and yaw data, and/or portions of the image that depict distinctive or distinguishable architectural, geographic, or astronomical information.

As depicted in element 502, the method 500 also includes determining, based at least partially on the information, that the image depicts a location associated with an individual affiliated with the user. In example implementations of element 502, determining, based at least partially on the information, that the image depicts location associated with an individual associated with the user includes comparing the information associated with the captured image with data describing individuals associated with the user and locations associated with those individuals. The individuals mentioned in element 502 may include any of the individuals described herein, including but not limited to the individuals described with respect to element 402 of FIG. 4.

A location associated with an individual may be any physical position where an individual has been, currently is, and/or is likely to be at some time in the future. Many people now share on the Internet and via other digital means information about their current and former employment, current and former residential addresses, educational institutions they have attended, places they have visited, businesses and events they have enjoyed, appointments, and plans for future activities. Some individuals may allow their friends and/or relatives to access GPS coordinates identifying the location of a mobile device used by the individual. In some implementations of element 502, information about such locations is analyzed to determine if a particular location is associated with an individual known to or otherwise associated with the user. For example, a user visiting a college campus may be interested in knowing if any of their friends, relative, or colleagues attended the school. Other users may be interested in knowing if any of their business contacts work in a particular building. Still other users may want to know if any of their friends hold tickets for seats near the user at a sporting event or music concert. If the desired location information about individuals is accessible by the user and/or the user's mobile device, such information can be compared to the locations depicted in the image captured by the mobile device to determine if any of the depicted locations are locations associated with an individual associated with the user. In further example implementations, element 502 includes comparing the information with data stored in a memory system. Such memory systems may include any of the memory systems described herein with respect to FIGS. 1-4 and/or element 501 above.

In some embodiments, the information provided by the real-time video stream may be compared to data provided to the system through an API. In this way, the data may be stored in a separate API and be implemented by request from the mobile device and/or server accesses another application by way of an API.

FIG. 5 also includes a depiction of element 503, which includes presenting via the mobile device of the user an indication associated with the location. Any of the implementations of presenting an indication via the mobile device as discussed with respect to FIGS. 1-4 above, including but not limited to the discussion with respect to element 403, may be applied to implementations of element 503. In some example implementations, an icon is superimposed over the depiction of the location viewable on the display of the mobile device. In other implementations, a border is superimposed around the depiction of the location, and viewable on the display of the mobile device.

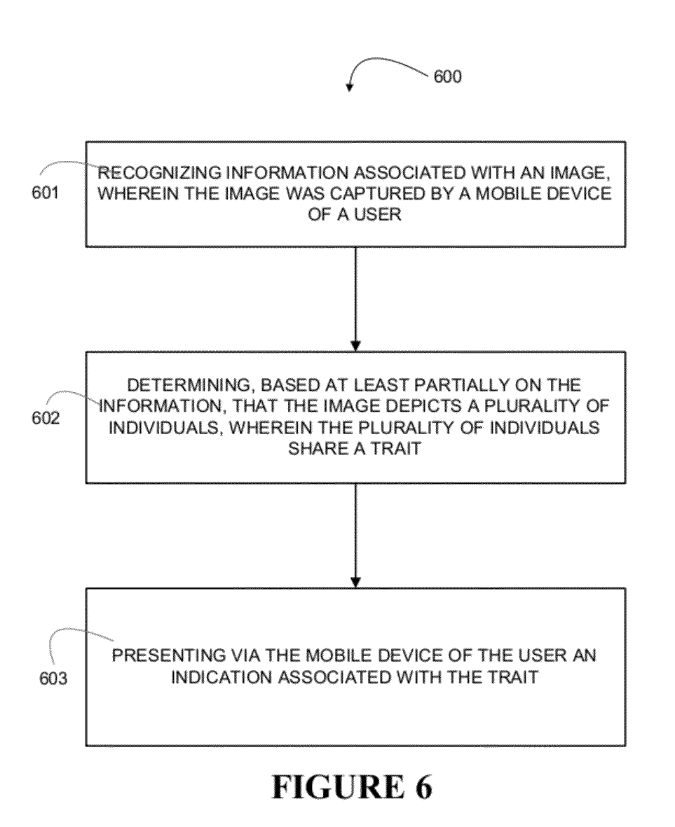

As shown in FIG. 6, method 600 depicts a method in accordance with another aspect of the invention. At element 601, the method 600 includes recognizing information associated with an image, wherein the image was captured by a mobile device of a user. It will be appreciated that any of the implementations described with respect to FIGS. 1-5, including but not limited to the implementations discussed with respect to elements 401 and 501 may be used in implementations of element 601. In some example implementations of element 601, information describing the location and/or orientation of the mobile device capturing the image is recognized along with geographic or architectural details depicted in the image to identify sections of a stadium, park, public venue, or other gathering place.

FIG. 6, also depicts element 602, which includes determining, based at least partially on the information, that the image depicts a plurality of individuals, wherein the plurality of individuals share a trait. Any of the implementations described with respect to elements 402 and 502, along with any other applicable implementations described with respect to FIGS. 1-5, may be used in example implementations of element 602. It will also be appreciated, however, that in many implementations of element 602, the term individual may apply to people not associated with the user. Rather, in element 602, the individuals share a trait. As used herein, a trait may be any aspect of an individual's background, personal history, personality, preferences, experiences, plans, affiliations, and/or relationships. In some example implementations, the trait is an indication of a product preference. Many people have become accustomed to indicating that they enjoy a particular food, beverage, brand, article of clothing, and/or other product by marking their preference on a social-networking website or by submitting a review or comment to any of a number of websites. In other implementations of element 602, the trait is an affiliation with an educational institution, such as a high school, college, or university that the individual or the individual's family members have attended or otherwise support. In other implementations of element 602, the trait is an affiliation with a business, such as a client relationship or employer/employee relationship with the business.

The method 600 also depicts element 603, which includes presenting via the mobile device of the user an indication associated with the trait. Any of the implementations of element 403 and 503 described herein, along with any other applicable implementation described with respect to FIGS. 1-5, may be used in implementations of element 603. In some example implementations of element 603, a plurality of selectable icons may be superimposed over depictions of individuals in the image displayed via the mobile device. In other implementations, a selectable border may be placed around a region of the image where the plurality of individuals is depicted.

In further implementations of the method 600, the method may include requesting, from the plurality of individuals, a response to a query; receiving a plurality of responses at a mobile device; and determining whether the plurality of responses indicate that one or more individuals share a trait. As used herein, the term query refers to any request for information and/or any invitation to supply information, such as advertisements, electronic messages transmitted to one or more individuals or devices, audio messages requesting information, video messages requesting information, in-person requests for information, and any other request that allows an individual to respond to a request for information or otherwise supply information.

For example, in locations where crowds tend to gather, such as stadiums, parks, movie theaters, airport terminals, bus depots, public buildings, large retail stores, and other such spaces, queries in the form of advertisements may be displayed, inviting people to visit a particular website, or send an electronic message to a particular number or address. When an individual responds to the request, data pertaining to the location of the individual, such as GPS coordinates, device ID, network location identification, or position of the advertisement may be collected with the response. The response information and location information can then be collected and/or received by a mobile device. Individuals who respond to the query, or respond in a similar manner to the query, may be considered to share a trait, and the location of those individuals may subsequently be displayed on the user's mobile device.

### Illustrative Example Implementations

With respect to the methods above, several example implementations are presented herein. These illustrative example implementations are presented merely to indicate some of the situations and scenarios in which some of the described and claimed methods may be performed. The illustrative example implementations are not exclusive and are not intended to define the full scope or limits on the scope of the claims, but rather are provided to assist in understanding aspects of the invention described and claimed herein. It will be appreciated that many of the details presented in the illustrative example implementations may be altered without placing the resulting scenario outside the scope of the invention.

### Example 1

A user of a mobile device attends a sporting event at a stadium. While approaching the section containing his seat, the user captures a real-time video stream of the section and the adjoining sections with his mobile device. The mobile device captures the real-time video stream and facial recognition information associated with the images in the real-time video stream. The mobile device then transmits the facial recognition information to a remote database where the user has stored images of his friends, family, business contacts, and other associates, and requests a comparison of the facial recognition information to the stored images. The mobile device also compares the facial recognition information against a collection of similar images stored in memory integrated with the mobile device. A match is identified and the mobile device receives a notification that the real-time video stream captured by the mobile device contains a depiction of an individual associated with the user. The mobile device indicates the presence of the individual by superimposing a border around the depiction of the individual on the display of the user's device. The user then selects the border and is presented with information indicating that the individual is a client whom the user has counseled regarding investments. From the mobile device, the user accesses his client's portfolio and recognizes that the client's portfolio could perform better if it was reconfigured to include some of the newer investments and financial products available from the user or the user's employer. Armed with this information, the user can then choose to greet his client, and set up an appointment to talk about improved financial options.

### Example 2

The user of a mobile device starts a new job in a part of town that he is unfamiliar with. Using his mobile device, he captures a real-time video stream of the buildings he can see from his office. The mobile device recognizes the GPS coordinates and compass directions associated with the real-time video stream and accesses a database listing the names of the viewed buildings and the businesses housed in those buildings. The mobile device compares the accessed information against location information associated with individuals known by the user. The mobile device determines that a former classmate of the user is the president of a company that resides in a building two blocks from the user. The mobile device superimposes an image of the face of the former classmate over the image containing a depiction of the building. Upon selecting the image, the user is directed via hyperlink to contact information for the former classmate and information generated by the user's employer regarding client development efforts directed toward the classmate's company. The user is then able to contact his former classmate and assist his new coworkers in their efforts to gain the classmate's company as a client.

### Example 3

The user of a mobile device attends a concert at a large venue. Interested in knowing if he knows anyone at the concert, he uses his mobile device to capture a real-time video stream of the crowd. The mobile device recognizes the GPS coordinates, compass directions, distinctive architectural features, and section numbers of the venue and identifies where the user is in relation to the layout of the venue. The mobile device also analyzes data posted online by friends, colleagues, and clients of the user, and finds a posting on a webpage or portion of a social networking website belonging to a client indicating that the client is at the concert. The posting also contains a link to data indicating the location of the client's seats. The mobile device determines that the client's seats are depicted in part of the real-time video stream, and superimposes an icon over the depiction of the seat. The user selects the icon, verifies that the client is the person in the seat, and is directed to a contact page saved in memory storage integrated with the mobile device, where the user can indicate that the client enjoys that concert venue and/or the musical group on stage.

### Example 4

While on vacation in an unfamiliar city, the user of a mobile device decides to try a new restaurant. While at a street corner, the user captures a still image with his mobile device. The mobile device recognizes the GPS and compass direction information associated with the image, a street sign depicted in the image, and distinctive architectural features depicted in the image to determine the user's precise location. The mobile device then analyzes information available on several websites, databases, and other web-accessible information sources to determine whether any individual associated with the user has provided information recommending a nearby restaurant. If the mobile device determines that a recommended restaurant is depicted in the image, the mobile device superimposes an icon or border around the section the image depicting the restaurant. After selecting the icon or border, the mobile device presents the user with information detailing who recommended the restaurant, when they recommended the restaurant, and any comments provided by the individual associated with the user.

### Example 5

The manager of food, beverage, and merchandise vending at a stadium is the user of a mobile device. During the course of a sporting event, he arranges for the monitors in the venue to invite attendees to respond to a series of questions. For example, during one portion of the event the monitors display a message inviting users to send a text message or visit a particular website if they like a particular beer. During a different portion of the game, the monitors advertise hot dogs or pizza, or other foods available at the venue. During yet another portion of the event, the monitors seek information about which attendees are supporting which team at the event. When attendees respond, a database collects and stores information about the position of the responders. Throughout the event, the user of the device can capture images of all or part of the crowd. The mobile device then recognizes the GPS, compass directions, and other positional information associated with the captured image and compares that information with the collected positional information about the responders to the various queries presented on the monitors. If the mobile device determines that one or more responders are depicted in an image captured by the user, an indication of the position of that responder and the response that user provided is superimposed on the captured image. For example, responders who indicated a team preference could be indicated by an icon in their preferred team's uniform color.

With the information regarding the preferences of the attendees, the user can redeploy vendors to the sections most likely to purchase a particular food or beverage product, and reconfigure the content of merchandise stalls to place a particular team's apparel closer to the higher concentrations of that team's supporters. For example, if one section happens to contain a large number of people who prefer one beer over another, the user can concentrate sales efforts in that section. Similarly, if another section is filled primarily with younger attendees who are too young to purchase beer, but rather enjoy hot dogs, the user can increase the concentration of hot dog vendors in that section. With regards to team affiliation, if one or more sections strongly prefer one team over another, the user can adjust the merchandise inventory in stalls closest to those sections to reflect the preferences of the fans, making it more convenient for fans of a particular team to purchase their preferred merchandise.

### Example 6

After his child's piano recital, the user of a mobile device notices a person he doesn't immediately recognize speaking with his child. While walking over to his child, the user captures an image of the individual with his mobile device. The mobile device recognizes the logo on the person's attaché case and the facial recognition information associated with the image, and queries a database contained on the user's mobile device. The mobile device determines that the individual is associated with the user and displays the person's credentials on the display of the user's mobile device. The information presented on the user's mobile device reminds the user that the individual is the headmaster of a prestigious music conservatory that the child is eager to attend, and all three people are able to engage in a productive discussion regarding the child's musical career.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. | | |
| No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real Estate |
| | | Listings |
| 61/478,402 | Apr. 22, 2011 | Real-Time Video Image Analysis for an |
| | | Appropriate Payment Account |
| 61/478,405 | Apr. 22, 2011 | Presenting Investment-Related Information |
| | | on a Mobile Communication Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects |
| | | in a Video Stream Captured by a |
| | | Mobile Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With an |
| | | Identified Representation of an Object |
| 61/478,419 | Apr. 22, 2011 | Vehicle Recognition |
| 61/478,417 | Apr. 22, 2011 | Collective Network of Augmented Reality |
| | | Users |
| 61/508,985 | Jul. 18, 2011 | Providing Information Regarding Medical |
| | | Conditions |
| 61/508,946 | Jul. 18, 2011 | Dynamically Identifying Individuals |
| | | From a Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a |
| | | Mobile Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions |
| | | Based on Identification of Individuals |
| | | in an Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
recognizing information associated with an image, wherein the image was captured by a mobile device of a user;
determining, based at least partially on the information, that the image depicts an individual associated with the user; and
presenting via the mobile device of the user an indicator associated with the individual.

2. The method of claim 1, wherein the mobile device is a mobile phone.

3. The method of claim 1, wherein the image is part of a real-time video stream.

4. The method of claim 1, wherein the image is a still image captured by a digital camera.

5. The method of claim 1 wherein the information comprises Global Positioning System (GPS) coordinates.

6. The method of claim 1 wherein the information comprises a compass heading.

7. The method of claim 1 wherein the information comprises facial recognition data.

8. The method of claim 1 wherein the information comprises a portion of the image.

9. The method of claim 1 wherein recognizing information associated with an image comprises comparing the information with data stored in a memory system.

10. The method of claim 1 wherein determining, based at least partially on the information, that the image depicts an individual associated with the user comprises comparing the information with data stored in a memory system.

11. The method of claim 1 wherein presenting an indicator associated with the individual comprises displaying the indicator on a display of the mobile device.

12. The method of claim 1, wherein presenting an indicator associated with the individual comprises superimposing the indicator over real-time video that is captured by the mobile device.

13. The method of claim 12, wherein the indicator comprises a border that surrounds a depiction of the individual.

14. The method of claim 1, wherein the indicator is selectable by the user.

15. The method of claim 14, wherein responsive to a selection of the indicator by the user, information about the individual is presented on a display of the mobile device.

16. The method of claim 1, wherein the indicator is a hyperlink that directs the user to a website comprising information about the individual.

17. The method of claim 1 further comprising presenting information about the individual via the mobile device of the user.

18. A method comprising:
recognizing information associated with an image, wherein the image was captured by a mobile device of a user;
determining, based at least partially on the information, that the image depicts a location associated with an individual affiliated with the user; and
presenting via the mobile device of the user an indicator associated with the location.

19. A method comprising:
recognizing information associated with an image, wherein the image was captured by a mobile device of a user;
determining, based at least partially on the information, that the image depicts a plurality of individuals, wherein the plurality of individuals share a trait; and
presenting via the mobile device of the user an indicator associated with the trait.

20. The method of claim 19, wherein the trait is a product preference.

21. The method of claim 19 wherein the trait is an affiliation with an educational institution.

22. The method of claim 19 wherein the trait is an affiliation with a business.

23. The method of claim 19 further comprising:
requesting, from the plurality of individuals, a response to a query;
receiving a plurality of responses at a mobile device; and
determining whether the plurality of responses indicate that one or more individuals share a trait.

24. An apparatus for providing location identification information, the apparatus comprising:
a computing device comprising a memory and at least one processor; and
a location identification application stored in memory, executable by the processor, and configured to:
recognize information associated with an image, wherein the image was captured by a mobile device of a user;
determine, based at least partially on the information, that the image depicts an individual associated with the user; and
present via the mobile device of the user an indicator associated with the individual.

25. The apparatus of claim 24, wherein the mobile device is a mobile phone.

26. The apparatus of claim 24, wherein the image is part of a real-time video stream.

27. The apparatus of claim 24, wherein the image is a still image captured by a digital camera.

28. The apparatus of claim 24, wherein the information comprises Global Positioning System (GPS) coordinates.

29. The apparatus of claim 24, wherein the information comprises a compass heading.

30. The apparatus of claim 24, wherein the information comprises facial recognition data.

31. The apparatus of claim 24, wherein the information comprises a portion of the image.

32. The apparatus of claim 24, wherein recognizing information associated with an image comprises comparing the information with data stored in a memory system.

33. The apparatus of claim 24, wherein determining, based at least partially on the information, that the image depicts an individual associated with the user comprises comparing the information with data stored in a memory system.

34. The apparatus of claim 24, wherein presenting an indicator associated with the individual comprises displaying the indicator on a display of the mobile device.

35. The apparatus of claim 24, wherein presenting an indicator associated with the individual comprises superimposing the indicator over real-time video that is captured by the mobile device.

36. The apparatus of claim 35, wherein the indicator comprises a border that surrounds a depiction of the individual.

37. The apparatus of claim 24, wherein the indicator is selectable by the user.

38. The apparatus of claim 37, wherein the location identification application is further configured to, based at least partially on a selection of the indicator by the user, present information about the individual on a display of the mobile device.

39. The apparatus of claim 24, wherein the indicator is a hyperlink that directs the user to a website comprising information about the individual.

40. The apparatus of claim 24, wherein the location identification application is further configured to present information about the individual via the mobile device of the user.

41. An apparatus for providing location identification information, the apparatus comprising:
a computing device comprising a memory and at least one processor; and
a location identification application stored in memory, executable by the processor, and configured to:
recognize information associated with an image, wherein the image was captured by a mobile device of a user;
determine, based at least partially on the information, that the image depicts a location associated with an individual affiliated with the user; and
present via the mobile device of the user an indicator associated with the location.

42. An apparatus for providing location identification information, the apparatus comprising:
a computing device comprising a memory and at least one processor; and
a location identification application stored in memory, executable by the processor, and configured to:
recognize information associated with an image, wherein the image was captured by a mobile device of a user;
determine, based at least partially on the information, that the image depicts a plurality of individuals, wherein the plurality of individuals share a trait; and
present via the mobile device of the user an indicator associated with the trait.

43. The apparatus of claim 42, wherein the trait is a product preference.

44. The apparatus of claim 42 wherein the trait is an affiliation with an educational institution.

45. The apparatus of claim 42 wherein the trait is an affiliation with a business.

46. The apparatus of claim 42 wherein the location identification application is further configured to:
request, from the plurality of individuals, a response to a query;
receive a plurality of responses at a mobile device; and
determine whether the plurality of responses indicate that one or more individuals share a trait.

47. A computer program product comprising:
a non-transitory computer-readable medium comprising:
a first set of codes for causing a computer processor to be configured for recognizing information associated with an image, wherein the image was captured by a mobile device of a user;
a second set of codes for causing a computer processor to be configured for determining, based at least partially on the information, that the image depicts an individual associated with the user; and
a third set of codes for causing a computer processor to be configured for presenting via the mobile device of the user an indicator associated with the individual.

48. The computer program product of claim 47, wherein the mobile device is a mobile phone.

49. The computer program product of claim 47, wherein the image is part of a real-time video stream.

50. The computer program product of claim 47, wherein the image is a still image captured by a digital camera.

51. The computer program product of claim 47 wherein the information comprises Global Positioning System (GPS) coordinates.

52. The computer program product of claim 47 wherein the information comprises a compass heading.

53. The computer program product of claim 47 wherein the information comprises facial recognition data.

54. The computer program product of claim 47 wherein the information comprises a portion of the image.

55. The computer program product of claim 47 wherein recognizing information associated with an image comprises comparing the information with data stored in a memory system.

56. The computer program product of claim 47 wherein determining, based at least partially on the information, that the image depicts an individual associated with the user comprises comparing the information with data stored in a memory system.

57. The computer program product of claim 47 wherein presenting an indicator associated with the individual comprises displaying the indicator on a display of the mobile device.

58. The computer program product of claim 47, wherein presenting an indicator associated with the individual comprises superimposing the indicator over real-time video that is captured by the mobile device.

59. The computer program product of claim 58, wherein the indicator comprises a border that surrounds a depiction of the individual.

60. The computer program product of claim 47, wherein the indicator is selectable by the user.

61. The computer program product of claim 60 further comprising a set of codes configured to cause a computer processor to, at least partially in response to a selection of the indicator by the user, present information about the individual on a display of the mobile device.

62. The computer program product of claim 47, wherein the indicator is a hyperlink that directs the user to a website comprising information about the individual.

63. The computer program product of claim 47 further comprising a set of codes configured to cause a computer processor to present information about the individual via the mobile device of the user.

64. A computer program product comprising:
a non-transitory computer-readable medium comprising:
a first set of codes for causing a computer processor to be configured for recognizing information associated with an image, wherein the image was captured by a mobile device of a user;
a second set of codes for causing a computer processor to be configured for determining, based at least partially on the information, that the image depicts a location associated with an individual affiliated with the user; and
a third set of codes for causing a computer processor to be configured for presenting via the mobile device of the user an indicator associated with the location.

65. A computer program product comprising:
a non-transitory computer-readable medium comprising:
a first set of codes for causing a computer processor to be configured for recognizing information associated with an image, wherein the image was captured by a mobile device of a user;
a second set of codes for causing a computer processor to be configured for determining, based at least partially on the information, that the image depicts a plurality of individuals, wherein the plurality of individuals share a trait; and
a third set of codes for causing a computer processor to be configured for presenting via the mobile device of the user an indicator associated with the trait.

66. The computer program product of claim 65, wherein the trait is a product preference.

67. The computer program product of claim 65 wherein the trait is an affiliation with an educational institution.

68. The computer program product of claim 65 wherein the trait is an affiliation with a business.

69. The computer program product of claim 65 further comprising:
a fourth set of codes for causing a computer processor to be configured for requesting, from the plurality of individuals, a response to a query;
a fifth set of codes for causing a computer processor to be configured for receiving a plurality of responses at a mobile device; and
a sixth set of codes for causing a computer processor to be configured for determining whether the plurality of responses indicate that one or more individuals share a trait.
